(19) United States
(12) Patent Application Publication
(10) Pub. No.: US 2026/0169733 A1
(43) Pub. Date: Jun. 18, 2026

(54) SOFTWARE APPLICATION MANAGEMENT

(71) Applicant: SPECIFIC-GROUP MD USA LLC, Seattle, WA (US)

(72) Inventors: Josef Bartholomäus SCHIEFER, Bellevue, WA (US); Marcus-Emanbuel BRANDSTETTER, Vienna (AT); Aliaksandr KHARUZHY, Warsaw (PL)

(21) Appl. No.: 18/980,963

(22) Filed: Dec. 13, 2024

(51) Int. Cl. G06F 8/73; G06F 16/901; H04L 51/02

(52) U.S. Cl. CPC G06F 8/73; G06F 16/9024; H04L 51/02

(57) ABSTRACT

A computer-implemented method comprises receiving a documentation outline comprising a structure and topics and receiving, for each topic, a documentation page generator comprising natural language instructions on what to be displayed on a page and formatting details for the page. The method further comprises, for each documentation page generator, extracting relevant data using a knowledge graph representation of a software application, and using a large language model LLM pipeline to process the retrieved data and generate documentation content. The LLM pipeline comprises at least one LLM processor, each processor generating, using an LLM, a section of the documentation content. The LLM pipeline also comprises conditional logic or a loop construct. The generated documentation content is stored.

### TECHNICAL FIELD

The present invention relates to management of software applications.

### BACKGROUND

A software application is often accompanied by documentation including written text which explains how the software operates and how to use it. Documentation for an application is typically produced manually and constraints on developer time and resources mean that documentation can be brief and out of date.

The embodiments described below are provided by way of example only and are not limiting of implementations which solve any or all of the disadvantages of known methods for document generation.

### SUMMARY

This summary is provided to present a selection of concepts disclosed herein in a simplified form, which are described in more detail below. This summary is not intended to identify key features or essential features of the claimed subject matter nor is it intended to be used to limit the scope of the claimed subject matter.

A computer-implemented method comprises receiving a documentation outline comprising a structure and topics and receiving, for each topic, a documentation page generator comprising natural language instructions on what to be displayed on a page and formatting details for the page. The method further comprises, for each documentation page generator, extracting relevant data using a knowledge graph representation of a software application, and using a large language model LLM pipeline to process the retrieved data and generate documentation content. The LLM pipeline comprises at least one LLM processor, each processor generating, using an LLM, a section of the documentation content. The LLM pipeline also comprises conditional logic or a loop construct. The generated documentation content is stored.

### DESCRIPTION OF THE DRAWINGS

The present description will be better understood from the following detailed description read in light of the accompanying drawings, wherein:

FIG. 1 is a schematic diagram showing documentation generation;

FIG. 2 is a schematic diagram showing an example knowledge graph 200;

FIG. 3 is a schematic diagram showing an example LLM pipeline;

FIG. 4 is a flow diagram showing a method for automatically updating a documentation page;

FIG. 5 is schematic diagram showing an example chatbot interface;

FIG. 6 is a flow diagram showing an example computer-implemented method for generating documentation for a software application; and

FIG. 7 illustrates an exemplary computing-based device.

### DETAILED DESCRIPTION

The following description is presented in connection with the appended drawings and is intended as a description of the present examples to enable a person skilled in the art to make and use the invention. The description is not intended to represent the only forms in which the present examples are constructed or utilized. The present invention is not limited to the embodiments described herein and various modifications to the disclosed embodiments will be apparent to those skilled in the art.

Software applications comprise a program or group of programs which perform specific tasks. Accompanying documentation may comprise written materials that describe architecture, functionality, and/or usage instructions. Complex architecture and code dependencies make applications challenging to understand and use without suitable documentation.

Commonly used methods of producing documentation for a software application include manual documentation by developers. However, developers under time and resource constraints often produce low quantities of unreliable documentation, which can be brief and out of date. Outdated documentation, for example, makes software applications difficult to use. Furthermore, each time a change is made to the code base the documentation becomes outdated requiring continued human effort and time.

Disclosed herein are various methods and systems for generating documentation for a software application. Some methods use a generative model such as a large language model (LLM) and information about the software application stored in a knowledge base. Using an LLM streamlines the documentation process and provides comprehensive and accurate content which may be tailored to use scenarios or particular needs. Information from the knowledge base is in various examples extracted using a knowledge graph representation of the software application. A knowledge graph provides a way to efficiently and accurately extract relevant information from the knowledge base. A knowledge graph allows for efficient representation and querying of relationships between software artifacts

Methods disclosed herein result in increased efficiency and consistency during documentation generation, and provide documentation which can be updated and maintained efficiently. Such improved documentation saves developer time, and also allows new and current users of the application to use and maintain the application in a more efficient and improved manner.

Documentation for a software application can be divided into pages. A documentation page may correspond to a topic and include structured and formatted text describing the topic. In methods described herein, a documentation page includes documentation content comprising information (e.g. text), which is formatted to produce the documentation page.

In various examples of the present disclosure, a user provides a documentation outline which comprises a structure and topics of documentation comprising one or more pages. For each topic, a documentation page generator is received. A documentation page generator comprises natural language instructions on what to be displayed on a page and formatting details for the page. In other words, the documentation page generator comprises configuration information for each content. The received user input (documentation outline and documentation page generator(s)) allows the user to define desired properties of the produced documentation, meaning that the structure and content of the documentation suits the user's needs.

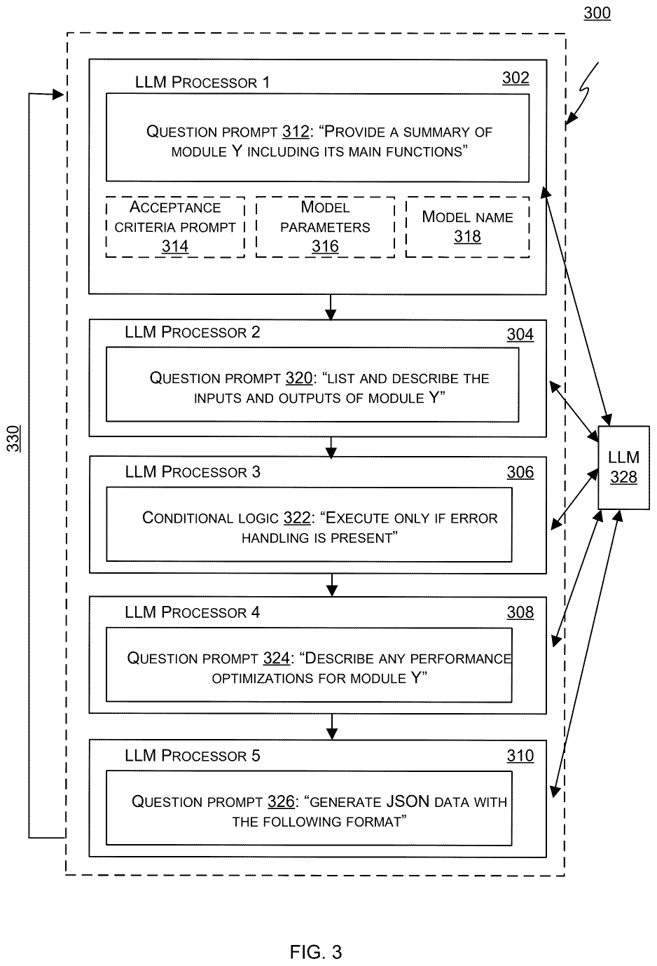

In response to receiving a document page generator, a document page generator job may be executed. The document page generator job generates documentation content. Content is generated by extracting relevant data from a knowledge graph, and executing an LLM pipeline. The LLM pipeline processes retrieved data and generates content. An LLM pipeline is a structured sequence of one or more LLM processors, each of which generates a section of documentation content. The LLM processors in various examples are arranged to manage data flow and control interaction between multiple LLM processors. This allows documentation content and relevant data to be processed efficiently and means that produced documentation content is accurate. LLM pipelines and processors are described in more detail below for example with reference to FIG. 3.

Sometimes the LLM pipeline comprises conditional logic and this can allow the pipeline to handle multiple data scenarios. Sometimes the LLM pipeline comprises a loop construct. This allows for iterative processing for example over a collection items e.g. programs, classes, database tables. This improves efficiency as parts of the LLM pipeline can be repeated rather than starting from scratch for the next item in the list of items. In further examples where the LLM pipeline comprises a loop construct, the pipeline also dynamically generates a list based on data from the knowledge base and iterates over the dynamically generated list. For example, the dynamically generated list is a list of all programs. Generating a list to iterate over means that documentation is accurate as it contains comprehensive coverage of all items in the list.

In some scenarios, once content is generated it is rendered using a template and may be indexed.

In various examples, a documentation page generator job which generates documentation content executes automatically and is triggered based on a schedule or based on a triggering event such as a change in the software application. This means that the documentation is kept up to date and saves developer time and effort in manually triggering the job. In response to a change in the software application, documentation content may be regenerated or updated using the knowledge graph and LLM pipeline.

As mentioned above, a documentation page can be generated by rendering documentation content. In various examples rendering is performed by applying a page template with macros to the generated content. This enables dynamic manipulation and formatting. This is an efficient way to obtain improved documentation.

Sometimes, linking and indexing is performed on the documentation page so that the documentation is straightforward to navigate. This also improves searchability of the documentation.

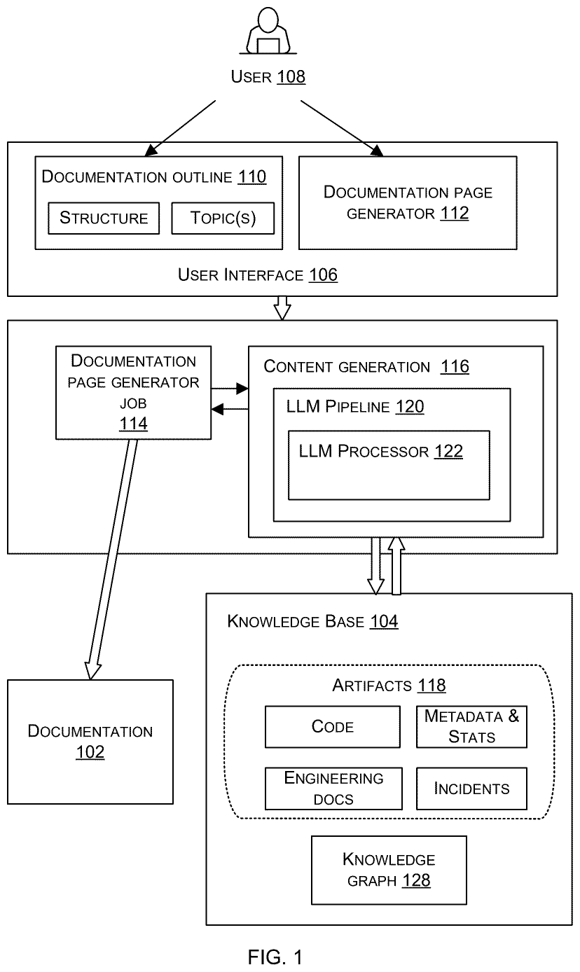

FIG. 1 is a schematic diagram showing documentation generation for generating documentation 102. A user 108 provides a documentation outline 110 at user interface 106. The documentation outline 110 defines the structure and topics to be included in the generated documentation. In various examples topics are subject areas or content blocks of documentation and documentation structure includes arrangement, hierarch and/or navigational flow of the documentation. Documentation structure may be called the underlying blueprint or scaffolding of the documentation. In a scenario, topics are identified, and then the identified topics are ordered and grouped to form a structure. For each of the topics provided in the documentation outline the user also provides a documentation page generator 112. Each documentation page corresponds to a provided topic. A documentation page generator is provided for each topic, to generate a page corresponding to that topic. The documentation page generator in various examples comprises natural language instructions about what should be displayed on the page and formatting details for the page. Formatting details for the page include but are not limited to: sections, tables, headings, subheadings, font, paragraph spacing, and line spacing. Sometimes the documentation page generator 112 includes a page template which determines the structure and layout of the final documentation page, incorporating styling and formatting guidelines. The user provides natural language instructions which make providing user input easy and user-friendly. A documentation page generator job 114 generates documentation content (shown at 116). Sometimes, a documentation page generator job 114 are triggered manually by the user. Other times, the jobs are scheduled or initiated by an event.

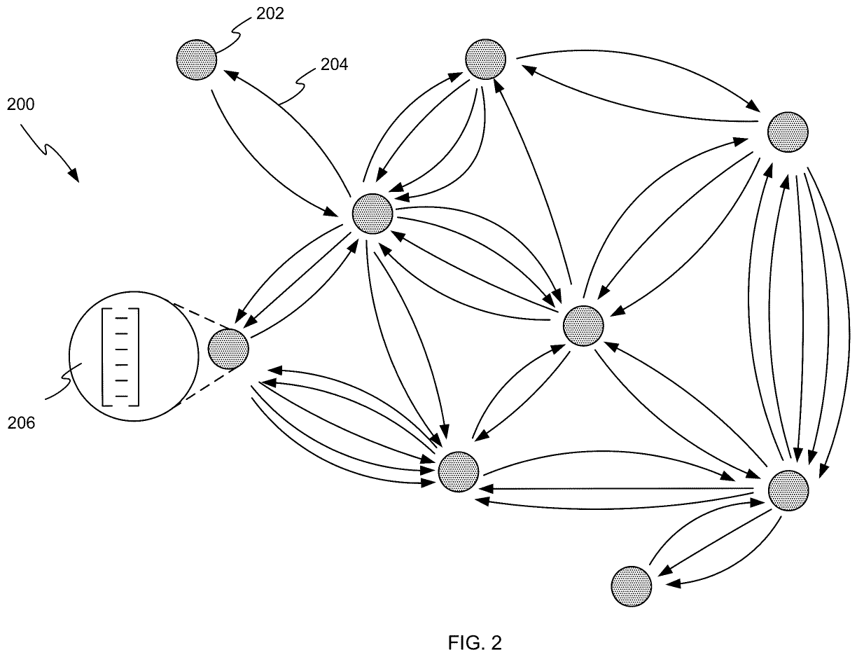

At 116 content is automatically generated for a documentation page. Content generation leverages information from a knowledge base 104 to produce documentation pages using a generative model, such as a large language model. Knowledge base 104 is graph-based and leverages a knowledge graph 128. As described in more detail below with respect to FIG. 2, the knowledge graph 128 efficiently represents and manages code dependencies and relationships between different software artifacts 118. As used herein, artifact refers to a concept which defines the structure or knowledge of program, source code or database. An artifact represents valuable information about an item or element within the software. In various examples an artifact is an item produced during the software development process. Examples of software artifacts include but are not limited to: Java classes, methods, routines, variables, code repository artifacts (e.g. code files, version histories, commit messages), documents, content, documentation, test cases, domain objects, and relationships between any of the former.

In various examples, a documentation page generation job 114 for a documentation page generator 112 includes extracting relevant data and using a large language model LLM to produce documentation content. Relevant data is extracted from knowledge base 104 using knowledge graph 128. In various examples, relevant data includes code snippets, database schemas, configurations, code comments, function definitions, usage examples and/or other artifacts. An LLM pipeline such as 120 is used to process the received data and generate documentation content. An LLM pipeline such as 120 comprises one or more LLM processors such as 122. Each processor generates a section of content using an LLM. An LLM pipelines further comprises conditional logic or a loop construct, described in more detail below. In various scenarios an LLM pipeline comprises a sequence of LLM processors. The LLM pipeline may also include prompts, acceptance criteria, and/or model parameters used to generate target content using an LLM. Generated documentation content is stored so that it may be accessed and used at a later time.

FIG. 2 is a schematic diagram showing an example knowledge graph 200. Knowledge graph 200 is an example of knowledge graph 128 in FIG. 1. Knowledge graph 200 includes nodes such as node 202 and edges such as 204. Edges link the plurality of nodes in the knowledge graph. Knowledge graph 200 is generated for example using data sources from the software application such as code repository artifacts, documentation and data and metadata from databases. In various examples, each node 202 stores data related to an artifact of the software application and each edge 204 represents a relationship between artifacts of the software application. For example a node represents an entity which could be a module, a database table, an error message, a function or any other suitable artifact. An example relationship between two nodes may be that a function is part of a module. Information about an entity represented by a node is annotated to the node in some cases, or a reference annotated to the node refers to a storage location where the information is stored.

Some example knowledge graphs are generated by a process which involves converting software code, configuration, or other structured files into a representation comprising a “textual” graph along with a set of facts associated with the graph's nodes and edges. A fact, also called a triple, is represented as text. A triple includes a subject, a predicate, and an object. The predicate describes the relationship between two nodes, the subject and the object. If a node is used in more than one triple then the node may be both a subject and an object simultaneously. In various scenarios, the process for generating example knowledge graphs uses traditional parsing techniques and/or machine learning models such as large language models which may be combined with categorization, normalization and duplicate checks.

In some scenarios, each node 202 stores a vector embedding of the artifact stored at, or referenced by the node. An example vector embedding is depicted at 206 in FIG. 2. For example, a node stores data related to a code snippet, and the node further stores a vector embedding of the code snippet. In various examples, embeddings are computed for facts, combined facts, and graph node structures (expressed as text) along with their combined facts. A vector embedding may be generated for example using an encoder model. The encoder model may be a neural network or any other suitable type of model. A non-exhaustive list of examples of encoder models which may be used is CLIP, BERT. Where two or more different encoder models are used, a mapping component maps the outputs of the different encoder models to a common embedding space.

Information from knowledge graph 200 may be retrieved by following edges such as 204 in the graph starting from a starting node. Each edge represents a relationship between the two nodes that the edge connects. Therefore, by retrieved artifacts in the nodes connected to the starting node, relevant information is retrieved. In some examples, information is retrieved from the knowledge graph using a vector search in vector space as well as by travelling along edges of the graph to find neighboring nodes of a starting node.

In various examples, relevant data may be retrieved from a knowledge graph representation of a software application using an artificial intelligence AI agent, which may be a specialized AI agent for example an agent specialized in a programming language.

As described above, during execution of a document page generator 112 relevant data is retrieved from a knowledge graph such as 128. Once relevant data is retrieved, an LLM pipeline such as 120 is used to process the received data and generate documentation content. In various scenarios during execution of an LLM pipeline, content for each documentation topic is produced which may be natural language content.

FIG. 3 is a schematic diagram showing an example LLM pipeline. An LLM pipeline comprises at least one LLM processor as well as conditional logic or a loop construct. An LLM processor is a component that interacts with a large language model to generate or refine documentation content. Given instructions an LLM processor queries the model, receives generated text, and may apply additional rules or formatting before passing the result along the documentation pipeline, for example to another LLM processor. In various examples described herein, an LLM pipeline is a structured sequence which dictates how LLM processors interact to produce coherent and contextually accurate documentation content. Example LLM pipeline 300 in FIG. 3 comprises fives LLM processors 302, 304, 306, 308, and 310. An LLM processor can be described as a unit within pipeline 300 which is responsible for generating specific pieces of content by interacting with LLM 328. Each processor may be configured with properties that determine its behavior. Some example properties are illustrated in LLM processor 1, 302. Example properties are shown with reference to LLM processor 1, 302, to represent the types of properties which may be configured for an LLM processor. Properties include a question prompt 312. A question prompt is input to an LLM such as LLM 328 which is formulated as a query or as an instruction. It defines the content that the processor aims to generate. In the example of FIG. 3, LLM processor 1 has a question prompt quality which is “provide a summary of module Y including its main functions”. Another example question prompt could be “describe the main functionalities of module X”. These question prompts direct the LLM to produce a detailed description of a particular module. Other example question prompts are shown in FIG. 3 with respect to LLM processors 2, 4, and 5. In further examples, an LLM processor such as any of the LLM processors shown in FIG. 3 may have properties including by not limited to: an acceptance criteria prompt 314, model parameters 316 and/or model name 318. In various scenarios, these LLM properties are included in the document page generator and provided by the user. An acceptance criteria prompt provides information about expectations for the output of the LLM, specifying the desired quality, completeness and format. An example acceptance criteria prompt 314 is “Ensure the description includes at least three key features and is written in a formal tone”. Model name 318 specifies which LLM 328 to use. In some examples the LLM is BERT or GPT, in other examples the LLM is a domain-specific model. Model parameters 316 are parameters associated with LLM 328. Some example model parameters are temperature, top_p and max tokens. Model parameters affect the creativity, randomness and length of generated text. In some examples, a lower temperature may result in more deterministic outputs suitable for technical documentation.

LLM pipeline 300 in the example shown in FIG. 3 manages the flow of data and controls interaction between multiple processors. For example, the data pipeline facilitates output from one LLM processor to be input to another LLM processor. This is represented by arrows in FIG. 3. Pipeline 300 integrates multiple processors, each responsible for different content aspects. Pipeline 300 in FIG. 3 includes conditional logic to handle varying data scenarios.

LLM processor 1, 302, generates an overview of a module Y and includes a question prompt 312 “Provide a summary of module Y including its main functions”. The prompt is provided as input to LLM 328 which return an output. LLM processor 2, 304, details the inputs and outputs of module Y and includes a question prompt 320 “list and describe the inputs and outputs of module Y”. LLM processor 3, 306, explains error handling mechanisms, only if applicable and includes the conditional logic 322 “Execute only if error handling is present.” LLM processor 4, 308, summarizes performance considerations and includes the question prompt 324 “Describe any performance optimizations for module Y”. LLM processor 5, 310, generates JSON data for a bar chart and includes the prompt 326 “generate JSON data with the following format: . . . ”. Each of the prompts is provided to LLM 328 which generates a section of documentation content. Including conditional logic in an LLM pipeline means that the pipeline is able to handle a wider variety of data scenarios, leading to more accurate and efficiently generated documentation.

In various examples, LLM pipelines include loop constructs. In scenarios, one or more loop constructs within an LLM pipeline allow for iterative processing over collections of items such as programs, classes, or database tables. This means that a software application includes numerous components requiring similar documentation structures is processed efficiently and leads to consistency in the produced documentation. A loop construct is represented in FIG. 3 by arrow 330 which indicates that the steps are repeated for other modules such as a module X and a module Z.

Some LLM pipelines of the present disclosure include iteration over dynamic lists. These pipelines dynamically generate lists based on data from a knowledge base such as 104 and iterate over them. The list of items which is iterated over in some situations is provided by user-defined variables, for example a user defines a list of items. In another example, a list of items is dynamically calculated by running an LLM processor. For example, an LLM processor uses LLM such as 328 and knowledge base 104 to produce a list of modules.

In various examples, parameters are passed between LLM processors in an LLM pipeline such as pipeline 300. This allows for improved consistency and relevance of produced documentation. For example, one LLM processor may retrieve data about a specific module, and another processor uses data from the first processor to generate detailed content.

As described above, document page generation is achieved by execution of documentation page generators such as documentation page generator 112. Documentation page generation comprises content generation by retrieving data from a knowledge base using a knowledge graph such as graph 200 and executing an LLM pipeline such as pipeline 300 in FIG. 3.

Once the content is generated, some example methods include rendering the obtained documentation content. This may comprise integrating the generated content into a predefined page template. Sometimes a template is selected based on parameters such as a document outline, or the template is included in the document page generator 112 provided by user 108. The integration is performed for example using a markup language such as Markdown. Macros and placeholders in the template may be replaced with the generated documentation content. In some examples, content rendering comprises the following: accessing outputs from one or more LLM pipelines for example using macros to extract relevant data; selecting sections or elements from the LLM output which are relevant and/or discarding redundant elements; applying formatting; reordering content; adding an introduction, conclusion and/or transition. In various examples, macros are used to manipulate and render content dynamically.

Once documentation page content has been generated and the page rendered, document pages can be linked together. Sometimes documentation pages are linked together using internal links added to connected related pages, which enables users to navigate between different pages. For example, when a sub-page is generated a link is added to link back to the parent page.

Some methods described herein comprise automatically updating a documentation page. The update may be in response to a change in the software application such as a change in a configuration file, new code added, a deletion, change in variable name, addition of a function, change in dependency, and/or a change in a database schema. Sometimes, a change in the software application triggers an automatic documentation page update. Documentation pages associated with the change in software application can be identified based on querying knowledge base 104. For example, if a table definition changes only documentation pages referencing that table are identified using the knowledge base 104. This facilitates updates or partial updates of selected pages in some cases. In other cases, a full documentation update is triggered.

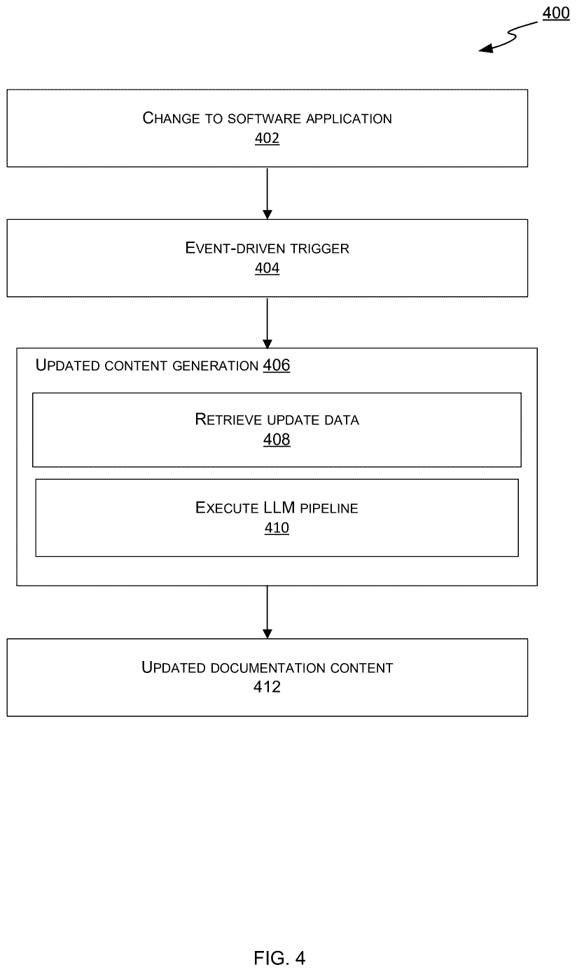

FIG. 4 is a flow diagram showing a method for automatically updating a documentation page. Method 400 comprises detecting a change to a software application 402. Examples of a change include but are not limited to a change in a configuration file, new code added, a deletion, change in variable name, addition of a function, change in dependency, and/or a change in a database schema. Change 402 may be detected in some examples using knowledge base 104. A source system may send a notification when a change occurs in response to which a documentation page is updated. In another example, a change is detected as a result of a periodic reloading of data corresponding to a software application. Data may be reloaded daily or weekly in various examples. Comparing newly loaded data with the previously stored data results in a change being detected by identifying which parts have changed.

The change to the software triggers an automatic update, as indicated in FIG. 4 by event-driven trigger 404. In response to trigger 404, updated content is generated at 406. Updated content is documentation content corresponding to an update which relates to a change in the software application 402. Updated content is generated 406 by retrieving update data 408 for example from knowledge base 104. Update data is data relevant to the change in the software. For example, if the change is a change in table definition, relevant data includes updated fields, data types, and index definitions of the table.. Once relevant data is retrieved, an LLM pipeline is executed 410 to generate updated content. In various scenarios, the LLM pipeline executed at 410 is the same LLM pipeline used to generate original documentation content, i.e. content produced before the change occurred. The LLM pipeline is used to re-evaluate existing prompts against updated source code or database data of the application. Using up-to-date data to generate the documentation results in an updated version of the documentation content. Executing the LLM pipeline results in updated documentation content 412.

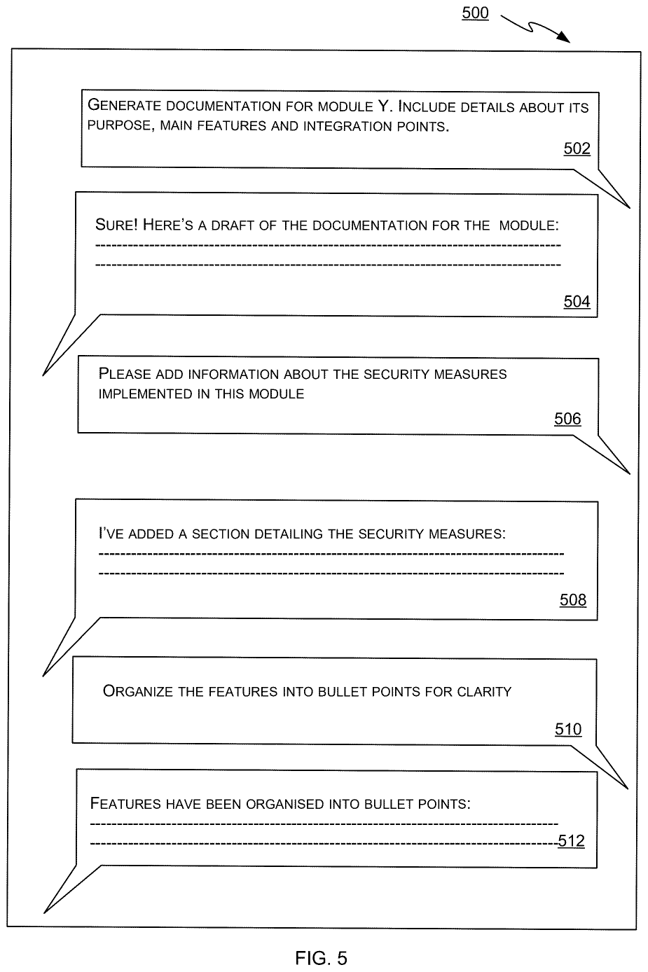

FIG. 5 is schematic diagram showing an example chatbot interface 500. In some examples chatbot interface 500 is part of user interface 106 in FIG. 1. Some methods described herein comprise receiving user input via a chatbot. The user input may include or be used to generate a documentation outline such as documentation outline 110, and a documentation page generator such as 112. A documentation outline comprises a structure and topics and a documentation page generator comprises natural language instructions on what to be displayed on a page and formatting details for the page. A page corresponds to a topic from the documentation outline. The user may find it easier to provide input via a chatbot interface.

At 502, the user provides a request for documentation for a module and asks for details about its purpose, main features and integration details. This corresponds to a document outline 110. At 504 the chatbot interface provides a draft of documentation for the module. The draft documentation is produced by generating documentation content by extracting relevant data using a knowledge graph and using an LLM pipeline to process the retrieved data. The chatbot interface 500 further allows input from the user relating to changes to the documentation, for example at 506 the user requests that security measures are added to the documentation. At 508 the chatbot displays updated documentation content generated by extracting relevant data using a knowledge graph and using an LLM pipeline to process the retrieved data. At 510 the user requests a formatting change and at 512 the chatbot displays content with changed formatting. The formatting change is achieved using an LLM. Interacting with a chatbot means that users can quickly iterate over drafts which saves developer time.

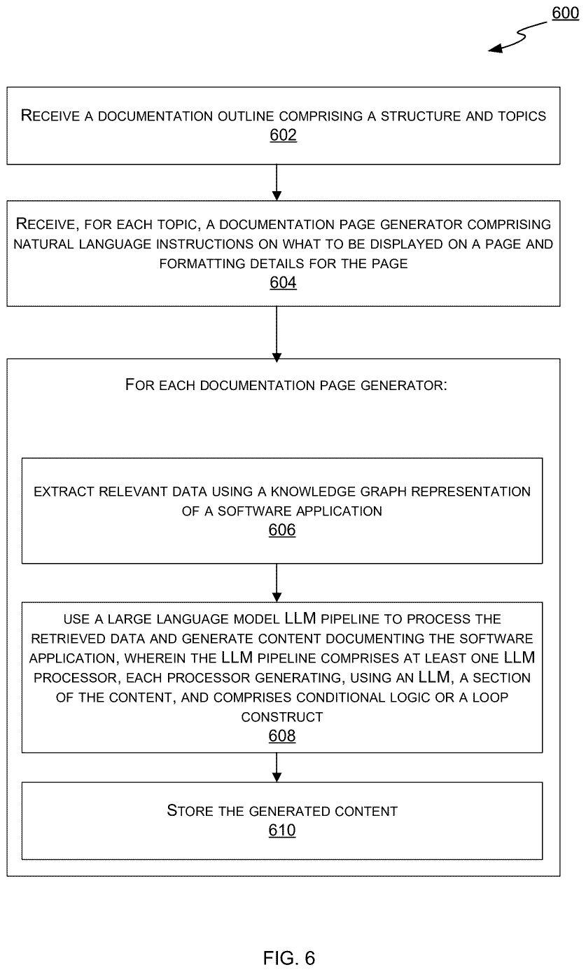

FIG. 6 is a flow diagram showing an example computer-implemented method 600. At block 602 a documentation outline is received. The documentation outline comprises a structure and topics. An example documentation outline is shown at 110 in FIG. 1. At 604, a documentation page generator is received. An example documentation page generator is shown at 112 in FIG. 1. The documentation page generator comprises natural language instructions on what to be displayed on a page and formatting details for the page. A documentation page generator is received for each topic in the documentation outline. For each documentation page generator, relevant information is extracted using a knowledge graph of a software application (such as knowledge graph 128 in FIG. 1 or 200 in FIG. 2). At block 608, a large language model LLM pipeline is used to process the retrieved data and generate content documenting the software application, wherein the LLM pipeline comprises at least one LLM processor, each processor generating, using an LLM, a section of the content, and comprises conditional logic or a loop construct. An example LLM pipeline is shown in FIG. 3. At block 610, the generated content is stored.

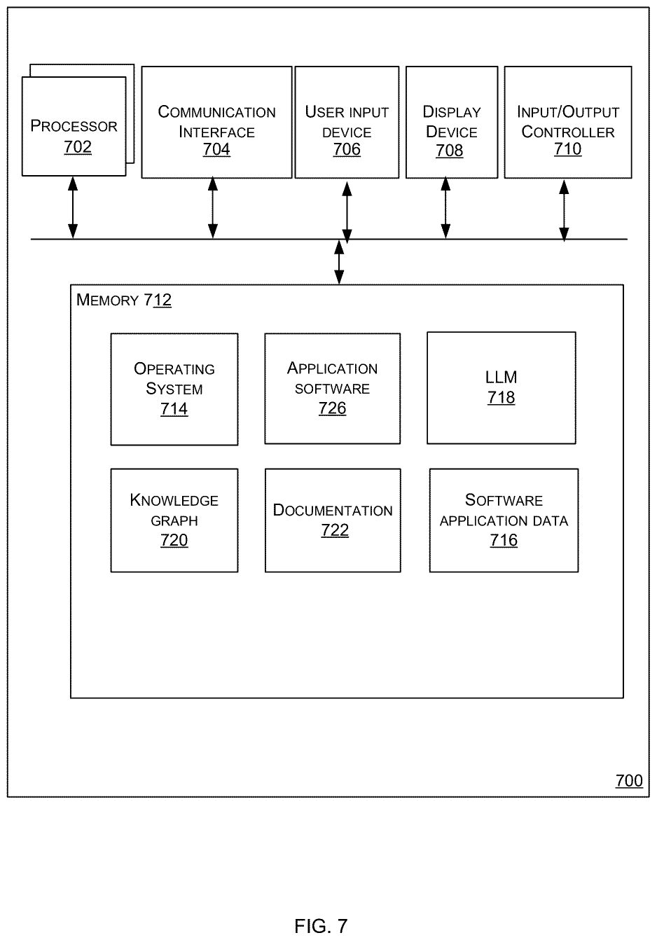

FIG. 7 illustrates various components of an exemplary computing-based device 700 which are implemented as any form of a computing and/or electronic device, and in which any of the methods described above are implemented in some examples.

Computing-based device 700 comprises one or more processors 702 which are microprocessors, controllers or any other suitable type of processors for processing computer executable instructions to control the operation of the device in order to respond to a query about a software application. In some examples, for example where a system on a chip architecture is used, the processors 702 include one or more fixed function blocks (also referred to as accelerators) which implement a part of the method of responding to a query about a software application in hardware (rather than software or firmware). Platform software comprising an operating system 714 or any other suitable platform software is provided at the computing-based device to enable application software 726 to be executed on the device. In various examples, software application data 716 is stored in memory 712. In further examples, also stored in memory 712 is a large language model 718 such as model 328, software application data 716 including artifacts of the software application for which documentation is being produced, a knowledge graph 720 such as 128, 200 and documentation 722 produced using methods described herein.

The computer executable instructions are provided using any computer-readable media that is accessible by computing based device 700. Computer-readable media includes, for example, computer storage media such as memory 712 and communications media. Computer storage media, such as memory 712, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 712) is shown within the computing-based device 700 it will be appreciated that the storage is, in some examples, distributed or located remotely and accessed via a network or other communication link (e.g. using communication interface 704).

The computing-based device 700 also comprises an input/output controller 710 arranged to output display information to a display device 708 which may be separate from or integral to the computing-based device 700. The display information may provide a graphical user interface. The input/output controller 710 is also arranged to receive and process input from one or more devices, such as a user input device 706 (e.g. a mouse, keyboard, camera, microphone or other sensor). In some examples the user input device 706 detects voice input, user gestures or other user actions. This user input may be used to receive a query at a user interface. In an embodiment the display device 708 also acts as the user input device 706 if it is a touch sensitive display device. The input/output controller 710 outputs data to devices other than the display device in some examples, e.g. a locally connected printing device (not shown in FIG. 7).

Alternatively or in addition to the other examples described herein, examples include any combination of the following: Clause A. A computer-implemented method comprising:
receiving a documentation outline comprising a structure and topics;
receiving, for each topic, a documentation page generator comprising natural language instructions on what to be displayed on a page and formatting details for the page;
for each documentation page generator:
   extracting relevant data using a knowledge graph representation of a software application;
   using a large language model LLM pipeline to process the retrieved data and generate documentation content,
   wherein the LLM pipeline comprises at least one LLM processor, each processor generating, using an LLM, a section of the documentation content, and comprises conditional logic or a loop construct; and
   storing the generated documentation content.

Clause B. The method of clause A, further comprising identifying a change in the software application and regenerating or updating the documentation content in response to identifying the change.

Clause C. The method of clause B, wherein regenerating or updating the documentation content comprises retrieving data corresponding to the change and executing an LLM pipeline.

Clause D. The method of any preceding clause, wherein each LLM processor comprises one or more of: a question prompt defining the section of the documentation content; acceptance criteria including more details about the section of the documentation content; a model name specifying an LLM to use; one or more model parameters for the LLM.

Clause E. The method of any preceding clause, wherein the conditional logic comprises instructions for a first scenario and a second scenario.

Clause F. The method of any preceding clause wherein the loop construct comprises a loop over a collection of items from the software application.

Clause G. The method of any preceding clause further comprising rendering the generated documentation content into a documentation page using a template.

Clause H. The method of clause G further comprising linking the documentation page to another documentation page and indexing the documentation page.

Clause I. The method of any preceding clause wherein the documentation outline and documentation page generator are received from a user at a graphical user interface

Clause J. The method of any preceding clause wherein the documentation outline and documentation page generator are received from a user at a chatbot interface and wherein the generated documentation content is displayed at the chatbot interface.

Clause K. The method of clause J wherein the user further provides natural language instructions for refining the generated content and in response refined documentation content is generated using an LLM pipeline and displayed at the chatbot interface.

Clause L. The method of any preceding clause wherein the knowledge graph comprises a plurality of nodes linked by edges wherein each node stores data related to an artifact of the software application and wherein each edge represents a relationship between artifacts of the software application, and wherein retrieving the relevant data comprises querying the knowledge graph.

Clause M. An apparatus comprising:
a processor; and
a memory storing instructions that, when executed by the processor, cause the processor to perform a method comprising:
receiving a documentation outline comprising a structure and topics;
receiving, for each topic, a documentation page generator comprising natural language instructions on what to be displayed on a page and formatting details for the page;
for each documentation page generator:
extracting relevant data using a knowledge graph representation of a software application;
using a large language model LLM pipeline to process the retrieved data and generate documentation content,
wherein the LLM pipeline comprises at least one LLM processor, each processor generating, using an LLM, a section of the documentation content, and comprises conditional logic or a loop construct; and
storing the generated documentation content.

Clause N. The apparatus of clause M wherein the method further comprises identifying a change in the software application and regenerating or updating the documentation content in response to identifying the change.

Clause O. The apparatus of clause N, wherein regenerating or updating the documentation content comprises retrieving data corresponding to the change and executing an LLM pipeline.

Clause P. The apparatus of any of clause M-O wherein the conditional logic comprises instructions for a first scenario and a second scenario.

Clause Q. The apparatus of any of clause M-P wherein the loop construct comprises a loop over a collection of items from the software application.

Clause R. The apparatus of any of clause M-Q wherein the knowledge graph comprises a plurality of nodes linked by edges wherein each node stores data related to an artifact of the software application and wherein each edge represents a relationship between artifacts of the software application, and wherein retrieving the relevant data comprises querying the knowledge graph.

Clause S. A computer system for automatically generating documentation for a software application, the system comprising:
a documentation outline module for receiving input from a user defining a structure and topics of the documentation;
a documentation page generator module for receiving natural language instructions on what to be displayed on a page and formatting details for the page and executing a job to generate documentation content wherein the job is triggered manually, on a schedule or by events;
a content generation service for retrieving relevant data using a knowledge graph representation of a software application and using a large language model LLM pipeline to process the retrieved data and generate documentation content, wherein the LLM pipeline comprises at least one LLM processor, each processor generating, using an LLM, a section of the documentation content, and the LLM pipeline comprises conditional logic or a loop construct.

Clause T. The system of clause S wherein the conditional logic comprises instructions for a first scenario and a second scenario or wherein the loop construct comprises a loop over a collection of items from the software application.

The term ‘computer’or ‘computing-based device’is used herein to refer to any

device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method comprising:
receiving a documentation outline comprising a structure and topics;
receiving, for each topic, a documentation page generator comprising natural language instructions on what to be displayed on a page and formatting details for the page;
for each documentation page generator:
extracting relevant data using a knowledge graph representation of a software application;
using a large language model LLM pipeline to process the retrieved data and generate documentation content,
wherein the LLM pipeline comprises at least one LLM processor, each processor generating, using an LLM, a section of the documentation content, and comprises conditional logic or a loop construct; and
storing the generated documentation content.

2. The method of claim 1, further comprising identifying a change in the software application and regenerating or updating the documentation content in response to identifying the change.

3. The method of claim 2, wherein regenerating or updating the documentation content comprises retrieving data corresponding to the change and executing an LLM pipeline.

4. The method of claim 1 wherein each LLM processor comprises one or more of: a question prompt defining the section of the documentation content; acceptance criteria including more details about the section of the documentation content; a model name specifying an LLM to use; one or more model parameters for the LLM.

5. The method of claim 1 wherein the conditional logic comprises instructions for a first scenario and a second scenario.

6. The method of claim 1 wherein the loop construct comprises a loop over a collection of items from the software application.

7. The method of claim 1 further comprising rendering the generated documentation content into a documentation page using a template.

8. The method of claim 7 further comprising linking the documentation page to another documentation page and indexing the documentation page.

9. The method of claim 1 wherein the documentation outline and documentation page generator are received from a user at a graphical user interface.

10. The method of claim 1 wherein the documentation outline and documentation page generator are received from a user at a chatbot interface and wherein the generated documentation content is displayed at the chatbot interface.

11. The method of claim 10 wherein the user further provides natural language instructions for refining the generated content and in response refined documentation content is generated using an LLM pipeline and displayed at the chatbot interface.

12. The method of claim 1 wherein the knowledge graph comprises a plurality of nodes linked by edges wherein each node stores data related to an artifact of the software application and wherein each edge represents a relationship between artifacts of the software application, and wherein retrieving the relevant data comprises querying the knowledge graph.

13. An apparatus comprising:
a processor; and
a memory storing instructions that, when executed by the processor, cause the processor to perform a method comprising:
receiving a documentation outline comprising a structure and topics;
receiving, for each topic, a documentation page generator comprising natural language instructions on what to be displayed on a page and formatting details for the page;
for each documentation page generator:
extracting relevant data using a knowledge graph representation of a software application;
using a large language model LLM pipeline to process the retrieved data and generate documentation content,
wherein the LLM pipeline comprises at least one LLM processor, each processor generating, using an LLM, a section of the documentation content, and comprises conditional logic or a loop construct; and
storing the generated documentation content.

14. The apparatus of claim 13 wherein the method further comprises identifying a change in the software application and regenerating or updating the documentation content in response to identifying the change.

15. The apparatus of claim 14, wherein regenerating or updating the documentation content comprises retrieving data corresponding to the change and executing an LLM pipeline.

16. The apparatus of claim 13 wherein the conditional logic comprises instructions for a first scenario and a second scenario.

17. The apparatus of claim 13 wherein the loop construct comprises a loop over a collection of items from the software application.

18. The apparatus of claim 13 wherein the knowledge graph comprises a plurality of nodes linked by edges wherein each node stores data related to an artifact of the software application and wherein each edge represents a relationship between artifacts of the software application, and wherein retrieving the relevant data comprises querying the knowledge graph.

19. A computer system for automatically generating documentation for a software application, the system comprising:
a documentation outline module for receiving input from a user defining a structure and topics of the documentation;
a documentation page generator module for receiving natural language instructions on what to be displayed on a page and formatting details for the page and executing a job to generate documentation content wherein the job is triggered manually, on a schedule or by events;
a content generation service for retrieving relevant data using a knowledge graph representation of a software application and using a large language model LLM pipeline to process the retrieved data and generate documentation content, wherein the LLM pipeline comprises at least one LLM processor, each processor generating, using an LLM, a section of the documentation content, and the LLM pipeline comprises conditional logic or a loop construct.

20. The system of claim 19 wherein the conditional logic comprises instructions for a first scenario and a second scenario or wherein the loop construct comprises a loop over a collection of items from the software application.
